(19) United States
(12) Patent Application Publication
(10) Pub. No.: US 2021/0023957 A1
(43) Pub. Date: Jan. 28, 2021

(54) Charging Station and Method for Transmitting Electrical Energy Between a Motor Vehicle which is Electrically Coupled to a Charging Station

(71) Applicant: Siemens Aktiengesellschaft, Muenchen (DE)

(72) Inventor: Klaus-Peter LINZMAIER, Winterbach (DE)

(21) Appl. No.: 17/041,027

(22) PCT Filed: Mar. 11, 2019
(86) PCT No.: PCT/EP2019/056000

§ 371 Date: Sep. 24, 2020

(30) Foreign Application Priority Data
Mar. 26, 2018 (EP) 18163960.0

(51) Int. Cl. B60L 53/66; H02J 7/00; B60L 53/12; B60L 53/18

(52) U.S. Cl. CPC B60L 53/66; H02J 7/00045; H02J 2310/48; B60L 53/18; B60L 53/12

(57) ABSTRACT

A method for transmitting electrical energy between a charging station and a motor vehicle which is electrically coupled to the charging station, in which the motor vehicle is coupled to the charging station via an electrical charging connection cable that includes at least two electrical lines, where a communication connection is produced between the charging station and the motor vehicle, the transmission of the electrical energy through the charging station is adjusted based on energy storage data transmitted from the motor vehicle to the charging station (10), and where the communication connection is produced at least partially over the at least two electrical lines of the electrical charging connection cable via at least one charging-station-side and at least one motor-vehicle-side communication adapter.

### CROSS-REFERENCE TO RELATED APPLICATIONS

This is a U.S. national stage of application No. PCT/EP2019/056000 filed 11 Mar. 2019. Priority is claimed on European Application No. 18163960.0 filed 26 Mar. 2018, the content of which is incorporated herein by reference in its entirety.

### BACKGROUND OF THE INVENTION

### 1. Field of the Invention

The invention relates to a control unit for controlling a charging unit that is used to transmit electrical energy to a motor vehicle which can be coupled to the charging unit via a charging connection cable comprising at least two electrical lines, where the control unit includes a communication interface that connects in a communications-compatible manner to the charging unit and is further configured to establish a communication connection to the motor vehicle and adjust the transmission of electrical energy through the charging unit as a function of energy-store data received from the motor vehicle.

The invention further relates to a charging station for transmission of electrical energy between the charging station and a motor vehicle that can be electrically coupled to the charging station, comprising a charging unit for transmitting the electrical energy, a control unit that is coupled in a communications-compatible manner to the charging unit, where the control unit is configured to establish a communication connection to the motor vehicle and adjust the transmission of electrical energy through the charging unit as a function of energy-store data received from the motor vehicle, and comprises an electrical charging connection cable that is electrically coupled to the charging unit and includes at least two electrical lines for the electrical coupling of the motor vehicle.

The invention further relates to a charging outlet for a charging station, where the charging outlet can be arranged spatially remote from a charging unit of the charging station to transmits the electrical energy and is configured to electrically couple to a motor vehicle, where the charging outlet comprises a control unit that is coupled in a communications-compatible manner to the charging unit, where the control unit is configured to establish a communication connection to the motor vehicle and adjust the transmission of electrical energy through the charging unit as a function of the energy-store data received from the motor vehicle, and an electrical charging connection cable which is coupled to the charging outlet and includes at least two electrical lines for the electrical coupling of the motor vehicle.

The invention further relates to a motor vehicle that has an electrical energy store, a charging connection unit that is electrically coupled to the electrical energy store and has at least two connection contacts, where the charging connection unit is configured to for electrical connect to an electrical charging connection cable of a charging station with at least two electrical lines for transmission of electrical energy between the charging station and the motor vehicle, and a vehicle control unit that is configured to establish a communication connection to the charging station and transfer energy-store data relating to the electrical energy store to the charging station via the communication connection to adjust the transmission of the electrical energy as a function of the energy-store data.

The invention further relates to a charging station to which a motor vehicle is electrically connected.

Lastly, the invention also relates to a method for transmission of electrical energy between a charging station and motor vehicle that is electrically coupled to the charging station, where the motor vehicle is coupled to the charging station via an electrical charging connection cable that includes at least two electrical lines, a communication connection is established between the charging station and the motor vehicle, and where the transmission of the electrical energy through the charging station is adjusted as a function of energy-store data transferred from the motor vehicle to the charging station.

### 2. Description of the Related Art

Motor vehicles particularly comprise land-based vehicles that can be operated by mechanical power in their normal running mode without being linked to a track system. The motor vehicle is preferably a motor car, in particular a private motor vehicle.

Motor vehicles preferably comprise electrically driven motor vehicles, i.e., motor vehicles that can be driven at least partially using electrical energy in the normal running mode. The electrical energy store is provided for this purpose, and provides an electrical drive unit of the motor vehicle with electrical energy for the normal running mode. The electrical energy store is discharged during the running mode, and must therefore be regularly recharged in order for the running mode to be able to be continued.

The charging of the energy store of the motor vehicle is effected by supplying energy from a charging station that is designed for this purpose and normally obtains its electrical energy from an electrical energy source, which can be, e.g., the public energy supply network or similar. However, the energy source can also be a solar installation, a turbine, a wind wheel and/or similar. Using an energy-compatible coupling, the energy is supplied from the charging station to the motor vehicle and here in particular to a charging connection unit that is electrically coupled to the electrical energy store.

For this purpose, the electrical energy store of the motor vehicle can be reversibly charged and discharged, and is usually designed as a type of accumulator. For electrically driven motor vehicles, use is generally made of an accumulator in the form of a high-voltage battery, which is often designed as a lithium-ion battery.

An electrically driven motor vehicle is therefore an electric vehicle or a hybrid vehicle in particular. In comparison with an electric vehicle, a hybrid vehicle also has a drive unit that is not electrically operated, often in the form of an internal combustion engine, which can likewise be deployed for the normal running mode to achieve a corresponding drive effect. In the hybrid vehicle, the electrical drive unit and the non-electrical drive unit can also be deployed in parallel to some degree in the normal running mode.

Control units, charging stations, motor vehicles and methods for supplying and/or bleeding off electrical energy, particularly in the context of electrically driven motor vehicles, are in principle disclosed extensively in the prior art, and therefore no separate written statement is required in relation to this. The motor vehicle has the charging connection unit, which allows the connection of an electrical charging connection cable of the charging station. The charging connection cable can then be used to supply electrical energy to the motor vehicle from the charging station or to bleed off electrical energy. This is therefore a line-based coupling for electrical energy.

The charging connection unit can have a plug connector for this purpose, in particular a detachable plug connector, via which an electromechanical coupling to the charging station can be established. For example, it can be envisaged that the motor vehicle is parked in the vicinity of the charging station and the charging station is connected electromechanically to the charging connection unit of the motor vehicle via the charging connection line via a plug connector of correspondingly complementary design. Electrical energy can then be supplied from the charging station to the motor vehicle. The energy is therefore provided by an electrical energy source external to the motor vehicle, namely the charging station or an energy source that is connected to the charging station, e.g., via the energy supply network cited above.

In many cases, the charging station also comprises a switched mode energy converter via which the charging connection cable of the charging station is electrically coupled. The switched mode energy converter, often designed in the form of a DC/DC converter and/or a controlled rectifier, is used to convert the electrical energy that is supplied by the energy source of the charging station in a manner that is suitable for the electrical energy store of the motor vehicle. The control unit of the charging station is usually designated for this purpose, where the control unit is connected to the energy converter and also inter alia controls the energy converter as a function of energy-store data relating to the electrical energy store of the motor vehicle, e.g., a charge state or state-of-charge (SOC).

The charging station is usually disposed in a positionally fixed manner. In addition to the connection of the charging station to the public energy supply network, it is also possible alternatively or additionally to connect a local energy source to the charging station in order to be able to supply the electrical energy. The local energy source can take the form of, e.g., one or more wind wheels, solar cells, fuel cells, or even a generator and/or similar driven via an internal combustion engine.

Typically, the charging station includes the charging unit via which the electrical energy is provided. The charging unit obtains its electrical energy from the electrical energy source to which the charging station is connected. The charging unit is coupled in a communications-compatible manner to the control unit, such that operating states of the charging unit can be transferred from the charging unit to the control unit and/or operating states of the charging unit can be controlled in accordance with control instructions issued by the control unit. The charging unit is connected to the electrical charging connection cable, via which the electromechanical coupling to the motor vehicle or electrically driven motor vehicle can be established. The connection of the charging connection cable to the motor vehicle is therefore a detachable connection because it does not normally exist in the normal running mode of the motor vehicle, particularly because the charging station is usually arranged in a positionally fixed manner.

In order to perform the charging procedure as smoothly as possible, it is beneficial to have communication between the motor vehicle, which is connected to the charging station via the charging connection cable, and the charging station. It is evidently beneficial for information to be available on the motor-vehicle side describing the charging power that the charging station is currently able to provide. At the same time, it is beneficial on the charging-station side to know the charge state of the energy store on the motor-vehicle side. Furthermore, it is beneficial for the charging station to know the electrical power that the energy store on the motor-vehicle side is able to accept. If a separate charging outlet is provided at the charging station, the it can be beneficial to know, e.g., the state of the charging outlet, whether, e.g., a motor vehicle is connected, whether ventilation is activated and/or similar.

In accordance with the prior art, for this purpose, a pilot line that allows a corresponding communication connection between the charging station and the motor vehicle or the charging outlet is usually provided. For example, the pilot connection line can arranged so as to be integrated into the charging connection cable, such that neither a separate line nor a separate plug-type connection need be operated. The communication that can be realized via the pilot line is covered by an existing standard, specifically DIN EN 61 851 in this case. The pilot line is preferably designed as a two-terminal line and is connected at both the motor-vehicle side or charging-outlet side and the charging-station side in a manner specified in the standard. The line can consist of a single pilot conductor and an electrical reference potential such as the ground potential.

It is also possible for the charging station to comprise a charging outlet that is arranged in a spatially remote manner from the charging unit, and to which the motor vehicle is coupled in an energy-compatible manner in order to supply electrical energy. This can be realized via a separate connection line between the charging outlet and the motor vehicle. Here, the charging connection cable is used to electrically connect the charging unit of the charging station to the charging outlet. The charging outlet can take the form of a dedicated device, such as a pillar or similar.

Even if the previously cited system is satisfactory with respect to the functionality of the pilot line, disadvantages are nonetheless evident. In particular, if the charging connection cable exceeds a specified maximum length, then interference can occur in relation to the communication, both on the motor-vehicle side and on the charging-outlet side. This can result in malfunctions, particularly during normal charging of the electrical energy store of the motor vehicle by the charging station.

It has also been observed that ground-based operation of the pilot line in particular only allows limited interference immunity. The range that is available for reliable communication is therefore restricted.

It should also be noted that, when using a technology based on charging the electrical energy store via a direct voltage that is supplied by the charging station as a charging voltage, a system layout is usually provided in which essentially only the electrical energy store is arranged on the motor-vehicle side, while the charging unit includes a suitable energy converter which can supply the charging voltage and via which it is possible to control the charging procedure for the electrical energy store of the motor vehicle. As a result of this system layout, energy-store data relating to the electrical energy store must be available on the charging-station side in order to realize the charging functionality, where the energy-store data corresponds to relevant parameters or states of the electrical energy store. Such parameters or states can include a temperature of the electrical energy store, a charge state, a maximum charging power, a rated voltage, a desired charging current value and/or similar. It is also possible for safety to be improved if additional communication contents can be defined and exchanged between the charging station and the motor vehicle.

For safe operation of the charging procedure or possibly a discharging procedure likewise, it is particularly beneficial for information to be available on the charging-station side, indicating whether the energy-compatible coupling has been reliably established. If the energy-compatible coupling is interrupted, then rapid interruption of the charging voltage is preferably provided for, particularly in the case of an abnormal separation of the energy-compatible coupling.

When using a ground-based pilot line, particularly with a plurality of charging stations or charging outlets, the same ground line is generally used as a reference potential and therefore crosstalk regularly occurs due to the propagation of the communication signals when this ground line is used. This can mean that the unambiguous assignment between the motor vehicle and the charging station or the charging outlet is no longer possible. This can result in hazardous states.

### SUMMARY OF THE INVENTION

It is an object of the invention is to improve the communication between the charging station or a charging outlet and the motor vehicle.

This and other object and advantages are achieved in accordance with the invention by a charging station, a charging outlet, a motor vehicle and a method, wherein the control unit is provided with a communication adapter, this being connectable to the at least two electrical lines, for establishing the communication connection to the motor vehicle via the at least two electrical lines.

With respect to the charging station of the type in question, the control unit is configured in accordance with the invention.

With respect to the charging outlet of the type in question, the control unit is configured in accordance with the invention.

With respect to the motor vehicle, the motor vehicle has a communication adapter, which is coupled in a communications-compatible manner to the vehicle control unit and is connected to the at least two connection contacts, for establishing the communication connection to the charging station via the at least two electrical lines.

With respect to the method in accordance with the invention, the communication connection is established at least partially via the at least two electrical lines of the electrical charging connection cable via at least one communication adapter on the charging-station side and at least one communication adapter on the motor-vehicle side.

Lastly, it is an object of the invention to provide a motor vehicle in accordance with the invention that is electrically connected to the charging station in accordance with the invention, in order to transmit electrical energy between the charging station and the motor vehicle.

The invention is based on the idea of completely dispensing with the pilot line that is used in the prior art to allow the communication between the motor vehicle and the charging station. It is thereby possible to avoid the associated disadvantages, particularly in relation to the reliability of the communication and the range. In this case, the invention is based on the idea of undertaking the communication via the electrical lines of the charging connection cable that are already available. In accordance with the invention, no separate communication lines are therefore required.

In accordance with the invention, the communication is effected by virtue of the communication adapters on the charging-station side and on the motor-vehicle side being able to apply communication signals onto the electrical lines of the charging connection cable, such that the charging connection cable can be used not only for the purpose of transmitting electrical energy from the charging station to the motor vehicle or vice versa, but at the same time also to allow communication via the same charging connection cable, in particular the electrical lines of the charging connection cable, via the communication signals. In this case, in accordance with the invention, the communication adapters on the charging-station side and on the motor-vehicle side have an essentially identical configuration, in principle. It is therefore not necessary to provide different communication adapters. However, it is nonetheless possible for the communication adapters to be configured differently if required. Moreover, the communication adapters can provide help functions that improve or if applicable also initially allow the communication via the lines of the charging connection cable. For this purpose, the electrical lines can be at least partially looped through the communication adapters or similar. For the purposes of the invention, however, it is in principle sufficient for the communication adapters to contact the electrical lines of the charging connection cable at least electrically. Instead of electrical contacting, however, it is also possible to envisage different via which the communication signals can be coupled in and out.

In principle, the invention requires at least two electrical lines of the charging connection cable for its implementation. If the charging connection cable is configured to receive a direct voltage as a charging voltage, then the charging connection cable need only comprise two electrical lines. In this case, these two electrical lines can be used by the communication adapters, e.g., contacted, in order to transmit the communication signals via the electrical lines.

It is, however, also possible for the charging connection cable to comprise more than two electrical lines, e.g., if the charging voltage takes the form of an alternating voltage, in particular a multi-phase alternating voltage, most preferably a three-phase alternating voltage. Here, it is sufficient for only two of the plurality of electrical lines of the charging connection cable to be used by the communication adapters or contacted by the communication adapters. Here, it must however then be taken into consideration that preferably the same electrical lines of the charging connection cable are contacted or used for the transmission of the communication signals on both the motor-vehicle side and the charging-station side respectively. This can also be specified via standardization or similar. In principle, it is naturally also possible in such a configuration for the communication adapters to contact a plurality and preferably all of the electrical lines of the charging connection cable and then determine which of the electrical lines should be used for the transmission of the communication signals. This increases the flexibility of the invention.

On the motor-vehicle side in particular, “contacting” of the electrical lines of the charging connection cable by the communication adapter signifies that the electrical lines are at least indirectly contacted. Indirect contacting, in this case, signifies that provision can be made on the motor-vehicle side for a plug connector that corresponds to the charging connection cable to be connected and has a respective connection contact, preferably for each of the electrical lines of the charging connection cable, which can be connected to the communication adapter. Here, the charging connection cable naturally has a corresponding complementary plug connector that is configured to electromechanical couple to the plug connector of the motor vehicle in a detachable manner. Naturally, direct contacting can also be provided.

With the communication adapters, which are preferably electrically coupled to the electrical lines of the charging connection cable in order to establish the communication connection, it is possible to establish a reliable and largely interference-proof communication connection. The pilot line that is usual in the prior art can therefore be dispensed with completely. By configuring the communication adapters in a suitable manner, it is moreover possible to extend the communication range almost without limit. The communication adapters can take line properties of the charging cable into consideration in this case, so that a reliable and as far as possible trouble-free communication connection can be achieved.

The transmission of electrical energy signifies in particular the supply of electrical energy in the form of a charging procedure for the electrical energy store. Furthermore, it can preferably also be understood to be the bleeding off of electrical energy from the electrical energy store in the form of a discharging procedure.

It is further proposed that the charging unit should be connected to an energy source external to the charging station in order to receive electrical energy, and that the charging unit should comprise an energy converter, in particular a switched mode energy converter, for converting the electrical energy received from the energy source. It is then advantageously possible to dispense with a potential corresponding energy converter on the motor-vehicle side, thereby saving expense and weight on the motor-vehicle side. It is moreover possible for the energy converter to be used more efficiently than can be achieved if the energy converter is arranged in the motor vehicle, because the energy converter can be used during the supply of electrical energy to a plurality of different motor vehicles. The energy converter would otherwise be usable by only a single motor vehicle, specifically that in which it is arranged.

The energy converter can be configured as a DC/DC converter, for example. Furthermore, the energy converter may also simply take the form of a rectifier, e.g., a bridge rectifier or similar. It should be understood that is also possible in principle to use a one-way rectifier or a two-way rectifier, though for reasons of efficiency these circuit topologies are generally less beneficial than a bridge rectifier in the field of energy technology. Combination circuits of rectifiers with DC/DC converters or similar can also be provided as energy converters. Furthermore, the energy converter can naturally also comprise one or more inverters or similar.

In order to further improve the reliability and/or the range of communication, provision can also be made for the energy converter to have means for reducing any electromagnetic coupling between the energy source and the charging connection cable. This coupling often takes the form of, e.g., line-based coupling or similar. The means for reducing the electromagnetic coupling can then be, e.g., a suitable filter, such as a radio interference filter or similar.

The reduction of the coupling can also be achieved by further circuit-oriented measures, e.g., by providing galvanic separation in the case of a DC/DC converter. These measures can naturally also be provided on the motor-vehicle side, e.g., between the charging plug connector of the motor vehicle, to which the communication adapter of the motor vehicle is also connected, and further components of the on-board network or the electrical energy store. These measures can naturally also be combined on both the charging-station side and on the motor-vehicle side.

In accordance of an embodiment, the energy converter should have means for reducing a capacitive and/or inductive coupling between the energy source and the charging connection cable. With this means, the communication connection likewise can be further improved with respect to quality. By virtue of a reduced capacitive coupling, it is possible, e.g., to reduce any attenuation of communication signals that are fed into the electrical lines by the communication adapter. Depending on the application case, particularly if communication signals with a low carrier frequency are used, this can also be relevant for an inductive coupling. Corresponding measures can be provided on the charging-station side. For example, provision can be made on the charging-station side for the energy source to be galvanically separated from the charging connection cable. Here, it is particularly advantageous if the galvanic separation ensures a particularly limited capacitive coupling by virtue of its properties, e.g., by virtue of suitably configured screening and/or similar.

In a further embodiment, the communication adapter is configured to use a modulation which is suitable for the line properties of the charging cable. This embodiment takes into consideration that, in the case of high frequencies, the charging cable can have specific line properties, e.g., a characteristic wave impedance, reflection properties at the ends of the charging connection cable and/or similar. Here, the modulation refers to the common procedure in the field of communications engineering whereby a payload signal that is to be transmitted changes or modulates a so-called “carrier signal”. The carrier signal normally has a significantly higher frequency than the highest frequency of the payload signal to be transmitted. For the purpose of sending the communication signals, the communication adapters therefore have a “modulator” that performs the corresponding modulation. Furthermore, signals received by the communication adapters are demodulated via suitable demodulators so that the respective payload signal can be retrieved. The carrier signal and the modulation can therefore ensure suitability for the physical properties of the charging connection cable. Modulation methods, both analog and digital, are disclosed extensively in the prior art, and therefore reference is made to the prior art in this regard.

Provision of digital modulation is particularly advantageous and, in an embodiment, the communication adapter is configured to use digital communication based on a secure protocol standard. A corresponding protocol standard can, for example, stipulate the use of specific data elements or data records to establish the communication connection. The data elements can have a predetermined specific data structure which preferably allows additional safety functions. For example, provision can be made for identification data to be exchanged between the charging station or the charging outlet and/or the motor vehicle. This data is preferably contained in each data element so that it can be confirmed on both the motor-vehicle side and on the charging-station side or charging-outlet side whether the data element is relevant for the charging station or the charging outlet or the motor vehicle. It is thereby possible to prevent data elements which reach the charging station or the motor vehicle as a result of unwanted effects, and which are not intended for this charging station or this motor vehicle, from being recognized as irrelevant by the charging station or the motor vehicle. This increases the safety because energy-store data that may be relevant for the charging procedure therefore cannot erroneously be recognized as intended for the respective charging procedure and therefore possibly result in unwanted malfunctions with respect to the charging procedure. The reliability of the communication connection can be significantly increased thereby.

The presently contemplated embodiment also allows additional security features to be provided, e.g., use of error-tolerant encoding, provision of encryption and/or identification data and/or similar. This can moreover prevent unauthorized third parties from interfering with the charging procedure. For example, use could be made of protocol standards that are based on, e.g., protocol standards as used on Ethernet or similar.

in a further embodiment, the protocol standard uses a monitoring time to monitor the communication connection. The monitoring time can be used to check whether the communication connection between the charging station or the charging outlet and the motor vehicle is still present. If the communication connection is interrupted, this could then signify an unintended state and the charging procedure can be terminated or interrupted on the charging-station side. Safety is thereby increased, particularly if, e.g., the plug-type connection of the charging connection cable has accidentally become detached at the plug connector of the motor vehicle or similar. This can be detected on the charging-station side and the charging voltage can be switched off. The overall safety can be improved by this means.

It is particularly advantageous if the monitoring time is less than 20 ms. As a result of selecting a short monitoring time such as this, it is possible both to ensure a high level of safety and comparatively rapidly to detect any impairment of the charging procedure. It is thereby possible to achieve a high level of safety by virtue of a rapid reaction, yet at the same time to maintain as far as possible the reliability of the normal supply of electrical energy during the normal charging procedure. Even if individual data elements in the communication connection are lost, or additional processing time is required at the communication adapters, this need not result in timeout errors and therefore cause an undesirable interruption of the supply of electrical energy.

In another embodiment, at least the communication adapter on the charging-station side is arranged remotely from the control unit. As a result, the communication adapter need not be arranged in a housing of the control unit. Rather, communication adapter can have its own housing and be coupled in a communications-compatible manner to the control unit by line-based and/or wireless means. It is thereby possible to achieve a high level of flexibility in the realization of the invention. The communication adapter can also be arranged at the charging outlet, for example.

It should be understood the functionality of the communication adapter on the charging-station side can also be provided at least to some extent in the communication adapter on the motor-vehicle side. In principle, the communication adapters can therefore also be configured identically.

In a further embodiment, a functional readiness of the charging station is indicated when the motor vehicle is electrically coupled to the charging station. It is thereby possible to communicate to the motor vehicle that the charging station or the charging outlet is likewise ready to supply or also receive electrical energy. This can allow the vehicle control entity to control the energy transmission procedure. It should also be understood it is also possible to thus indicate that the motor vehicle is correctly coupled to the charging station and therefore a user can start the energy transmission procedure. Further utilization options can also be made available in this manner.

In a further embodiment, the charging station tests a functionality of a protective conductor. The charging station can thus check a safety functionality, particularly with regard to the electrical safety. It is thereby possible to ensure that the transmission of the electrical energy only occurs when the safety is reliably ensured.

In accordance with an embodiment, a charging authorization is requested by the motor vehicle. The charging authorization can be used to notify the vehicle control entity that the transmission of energy can be started. This can be signaled at the vehicle, for example. In particular, it is possible to prevent a running mode of the motor vehicle from starting.

In a futher embodiment, ventilation is requested by the motor vehicle. It is thereby possible for the energy transmission procedure to be improved. As a result of the ventilation request, a cooling functionality can be provided that allows the energy transmission procedure to be continued or a transmitted power to be increased. In this way, it is possible to allow for the occurrence of losses during the energy transmission procedure, such as during the charging of the electrical energy store.

in accordance with a further embodiment, the charging station notifies the motor vehicle of a maximum power. In response to this notification, information can be provided to the charging station about the maximum power the motor vehicle is allowed to receive. This can therefore both serve as a safety function and can also enable the charging station to provide an optimum energy transmission procedure on a vehicle-specific basis at all times.

Furthermore, it should be understood the advantages and above-cited effects cited with respect to the control unit and the charging station apply equally to a charging outlet of the charging station and to the motor vehicle or the method of the invention and vice versa. In particular, that which can be stated in respect of device features can be applied to method features and vice versa.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantages and features can be derived from the following description of exemplary embodiments with reference to the appended figures, wherein in the figures, identical reference signs designate identical features and functions, in which:

FIG. 1 shows a schematic illustration of a charging station which is connected to a motor vehicle for the purpose of supplying electrical energy from the charging station to the motor vehicle in accordance with the invention;

FIG. 2 shows a schematic diagram of a data telegram with data elements as a communication signal, as used for the communication via the charging connection cable comprising two electrical lines as per FIG. 1 via respective communication adapters on the charging-station side and on the motor-vehicle side in accordance with the invention;

FIG. 3 shows a schematic diagram of a data element of the data telegram of FIG. 2; and

FIG. 4 is a flowchart of the method in accordance with the invention;

### DETAILED DESCRIPTION OF THE EXEMPLARY EMBODIMENTS

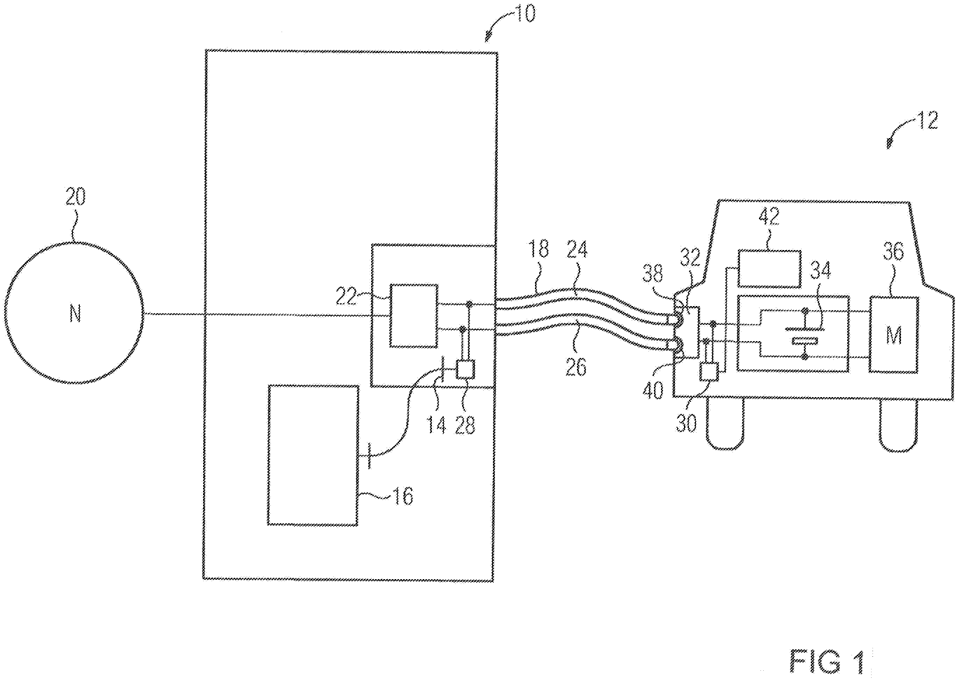

FIG. 1 shows a schematic illustration of a charging station 10 for supplying electrical energy to a motor vehicle 12 that is electrically coupled to the charging station 10 and is an electric vehicle in this case. In principle, the motor vehicle 12 can however also be a hybrid vehicle or a conventional motor vehicle.

The charging station 10 has a charging unit 14 that serves to provide electrical energy for the motor vehicle 12. To this end, the charging unit 14 is connected to an energy source 20 external to the charging station in order to receive electrical energy, where the energy source 20 in this case is a public energy supply network that provides the electrical energy using an alternating electrical voltage. In addition, the charging unit 14 here has an energy converter 22 that is used to convert the electrical energy that is received from the energy source 20. For this purpose, the energy converter 22 here is configured with a rectifier function and a DC/DC converter.

The charging station 10 further comprises a control unit 16 which is coupled in a communications-compatible manner to the charging unit 14 and is configured to establish a communication connection to the motor vehicle 12 and adjust the supply of electrical energy as a function of energy-store data received from the motor vehicle. For this purpose, the energy converter 22 can be suitably controlled by the control unit 16.

The charging station 10 further comprises an electrical charging connection cable 18 that is electrically coupled to the charging unit 14 and here comprises precisely two electrical lines 24, 26 for providing an electrical charging voltage, which is a direct voltage here.

The control unit 16 further comprises a communication adapter 28, which is coupled in a communications-compatible manner to the control unit 16 and is connected to the at least two electrical lines 24, 26, for establishing the communication connection to the motor vehicle 12 via the two electrical lines 24, 26.

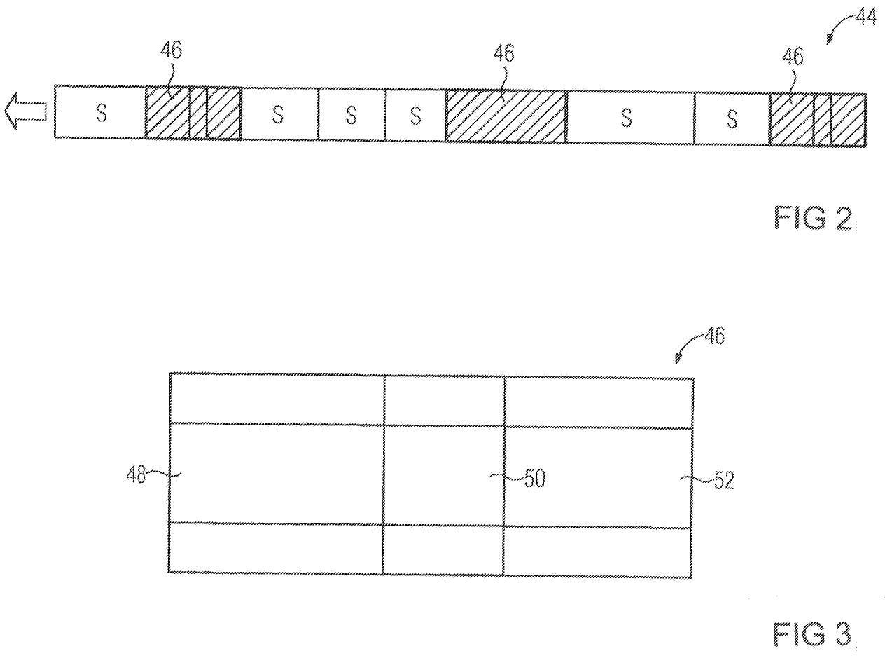

The communication adapter 28 is configured to use a modulation that is suitable for the line properties of the charging connection cable 18 and to this end has a correspondingly designed modulator (not shown) via which correspondingly modulated communication signals can be applied onto the two electrical lines 24, 26. In addition, the communication adapter 28 comprises a demodulator that is suitable for the modulation method and via which received communication signals can be demodulated. The communication signals can particularly comprise a data telegram 44 with data elements 46 as explained in greater detail below with reference to FIG. 2.

A quadrature amplitude modulation (QAM) is used, here. However, other suitable modulation methods can also be used.

Here, the charging station 10 is installed as a charging pillar at a parking space for the motor vehicle 12, such that the motor vehicle 12 parked in the parking space can be coupled to the charging station 10 via the charging connection cable 18 in an energy-compatible manner, i.e., electrically in particular, such that the charging station 10 can supply electrical energy to the motor vehicle 12.

It can also be seen from FIG. 1 that the motor vehicle 12 is connected to the charging station 10 via the charging connection cable 18. For this purpose, the motor vehicle 12 has a charging connection unit 32 with two connection contacts 38, 40 here, where the charging connection unit 32 is configured for electrical connection of the electrical charging connection cable 18 of the charging station 10, comprising the two electrical lines 24, 26 for providing the electrical charging voltage.

Furthermore, the motor vehicle 12 has an electrical drive unit 36 for driving the motor vehicle 12 in a normal running mode, and an electrical energy store 34 that is electrically coupled to the drive unit 36 and is configured as a lithium ion accumulator, in this case. A rated voltage of the electrical energy store 34 is, e.g., 450 V, here. This represents a high-tension voltage in the context of relevant standards, such as. ECE R 100. Requirements specified in standards must be met when operating electrical installations at high voltage. Both the charging station 10 and the motor vehicle 12 are appropriately configured for this.

The charging connection unit 32 is also electrically coupled to the energy store 34. For this, respective connection terminals of the energy store 34 are electrically coupled to corresponding connection contacts 38, 40 of the charging connection unit 32, such that electrical energy can be supplied to the energy store 34 when the motor vehicle 12 is connected to the charging station 10, as illustrated in FIG. 1. In principle, it is however also possible to draw electrical energy from the energy store 34 by this means.

The motor vehicle 12 also has a vehicle control unit 42, which is coupled in a communications-compatible manner to sensors (not shown), via which state variables and/or parameters of the electrical energy store 34 can be captured. Here, the state variables comprise a charge state and a temperature of the energy store 34. An electrical rated voltage and a charging power of the energy store 34 are captured as parameters. The vehicle control unit 42 is configured to establish a communication connection to the charging station 10 and transfer energy-store data to the charging station 10 via the communication connection to adjust the supply or also possibly withdrawal of electrical energy as a function of the energy-store data.

Here, the energy-store data comprises a charge state, a temperature, a rated power and a rated voltage of the electrical energy store 34. In addition to this, it is however also possible to add further state data relating to the electrical energy store 34 if necessary, or even to omit some of the previously cited energy-store data, if this is appropriate or beneficial for the current application.

The motor vehicle 12 further comprises a communication adapter 30, which is coupled in a communications-compatible manner to the vehicle control unit 42 and is connected to the two connection contacts 38, 40, for establishing the communication connection to the charging station 10 via the two electrical lines 24, 26 of the charging connection cable 18.

The communication adapter 30 is essentially configured identically to the communication adapter 28 of the charging station 10. However, the communication adapter 30 can also be configured differently if required, e.g., in order for vehicle-specific properties to be able to be taken into account. Both the communication adapter 28 and the communication adapter 30 are configured to provide a galvanic separation between the communication connection to the control unit 16 or vehicle control unit 42 and the electrical lines 24, 26. For this purpose, the communication adapters 28, 30 can have suitable transmitters that allow a communication signal to be output to the electrical lines 24, 26 without having to create a galvanic connection or an electrically conductive connection. For this purpose, provision can be made for the communication adapters 28, 30 to use a predetermined modulation.

It should be understood it is also possible for communication signals to be received by the communication adapters 28, 30 via the same communications-compatible coupling path. Received communication signals can be demodulated via the demodulators, decoded if applicable and also decrypted if necessary. For the purpose of sending, provision can therefore be made for the communication adapters 28, 30 to comprise a respective corresponding encoder and also a respective corresponding encryption device if applicable, in order for the data to be transmitted to be able to be provided in a suitable manner for the communication connection.

In principle, modulation can be effected using the widest possible range of modulation methods, such as amplitude modulation, frequency modulation, combinations of these, digital modulations and/or similar.

In order to improve the communication on the electrical lines 24, 26, provision is made here for the energy converter 22 to provide a galvanic separation. The lines 24, 26 are therefore electrically separated relative to a ground potential (not shown). It is thereby possible to reduce any unwanted capacitive coupling that could adversely affect the communication via the electrical lines 24, 26.

Furthermore, provision is made here for the communication adapters 28, 30 to be configured to use a digital communication based on a secure protocol standard. This is explained further below with reference to FIG. 2 and FIG. 3, which show a communication signal in a schematic illustration of a data telegram 44 with data elements 46, which the communication adapters 28, 30 can use to communicate with each other via the electrical lines 24, 26.

In order for operational safety without the requirement for a pilot line to be able to be ensured with respect to the communication during the charging or during the supply of electrical energy from the charging station to the motor vehicle, an association between the charging station 10 and the motor vehicle 12 is preferably established. Signaling should also be possible, at least of the charge state and preferably including any interruption of the supply of the electrical energy in the event of an error or if the charging connection cable 18 is detached from the charging connection unit 32. Furthermore, it should be possible not only to manage crosstalk, but preferably at least significantly reduce it. It is thereby also possible to reduce any latency in the communication and increase the bandwidth that is actually available for the communication.

In this way, the secure association between the charging station 10 and the motor vehicle 12 can be achieved by virtue of the communication signals no longer being ground-based using the pilot line, but instead being applied onto any desired electrical lines of the charging connection cable 18, the electrical lines 24, 26, here. If the charging is effected via a charging voltage which is a direct voltage, then a positive line and a corresponding negative line can be used. When using a charging voltage that is a single-phase alternating voltage, this can be a phase line and an associated zero line. If a multiphase (e.g., three-phase) alternating voltage is used as a charging voltage, provision can be made for the communication to be effected via at least two phase lines. It is therefore not necessary to use a ground line for the communication.

Attenuation of the crosstalk can be reduced if, when charging using a direct voltage, an energy converter or voltage converter or even a current source with limited coupling capacity is realized between an alternating-voltage side of the energy source 20 and a direct-voltage side (the charging connection cable 18 in this case), e.g., because even before the charging procedure or the supply of electrical energy is started, the connection of the charging connection cable 18 to the energy source 20 is already separated via a protection (not shown). If an alternating voltage is used as a charging voltage, then high-frequency filtering can be provided in a supply to the charging connection cable 18, e.g., at an energy supply or at a connection to the energy source 20 external to the charging station, or similar. The high-frequency filtering can comprise, e.g., a filter for line-based radio interference. An association mechanism, e.g., Session Layer Attenuation Characterization (SLAC), can therefore produce better results due to the reduced attenuation.

The secure transfer of charge states of the electrical energy store 34 can be achieved using automation engineering mechanisms via which the corresponding state data is transmitted, as described in greater detail below with reference to FIG. 2 and FIG. 3.

FIG. 2 shows a schematic illustration of a data telegram 44 of the type that can be used to establish the communication connection between the communication adapters 28, 30 via the electrical lines 24, 26. Here, the data telegram 44 comprises a sequence of a plurality of data stream segments S comprising standard data, including secure protocol data units (PDU) which are used for secure communication via the electrical lines 24, 26. A plurality of consecutive data stream segments S separate data elements 46, the structure of which is illustrated schematically in FIG. 3.

Provision is made here for a continuous data stream, which is bidirectional. As a result of the chosen modulation, the bidirectional communication connection can be established concurrently, thereby providing a full-duplex communication connection.

FIG. 3 shows a schematic illustration of one of the data elements 46 of FIG. 2, in which state information relating to the electrical energy store 34 can be transferred as F-input/output data 48. The F-input/output data 48 can comprise up to 123 bytes, for example. Status/control data 50 immediately follows the F-input/output data 48. This can comprise one byte of data.

This can be immediately followed by error-correction data, e.g., error-correction bytes 52, which may comprise three or even four bytes. Error-tolerant encoding of the data can be achieved via the error-correction bytes 52, such that upon receipt of the data element 46 the receiving side can check whether the F-input/output data 48 has been corrupted. Moreover, a certain number of errors can be corrected.

It is thereby possible to achieve a highly secure communication connection. Furthermore, it should also be understood that it is possible for the data that is to be transmitted in the data telegram 46 to be additionally encrypted to provide better security protection, particularly in relation to unauthorized intervention in the communication. Corresponding encryption algorithms can be provided for this purpose.

In order to achieve a high degree of safety in relation to the communication connection, a monitoring time can be prescribed, this being less than approximately 20 ms in this case, e.g., 16 ms or 8 ms or even less.

Following expiration of the monitoring time, a safety error can be detected and safety-critical settings, e.g., the energy supply from the charging station 10 to the motor vehicle 12, can be switched off. The inventive configuration of the system ensures optimal availability with respect to the data that must be transmitted.

The loss of individual data elements can therefore result in a slightly increased transmission latency and/or additional processing time in the communication adapters 28, 13, but a timeout error and consequential termination of the energy supply from the charging station 10 to the motor vehicle 12 can largely be avoided.

In order to further increase the safety of the communication connection, it is also possible to transmit a desired current value for the supply of electrical energy from the charging station 10 to the motor vehicle 12, preferably using the secure communication described above, e.g., in the same data element 46 with the previously described short cycle. In contrast with the cycle times of, e.g., 60 s used in the prior art, the choice of cycle time in accordance with disclosed embodiments of the invention allows a secure direct connection to be realized as a communication connection between the charging station 10 and the motor vehicle 12.

The data telegram 44 illustrated in FIG. 2 can be realized via framing as is customary with Ethernet, for example, specifically using corresponding Ethernet frames, for example. With reference to the OSI layer model, the disclosed embodiments of the invention allow a failure of the communication due to expiration of the monitoring time to be detected at layer 7. Overall, the disclosed embodiments of of invention also make it possible to monitor the sequence of the data elements 46.

Overall, it is possible to simplify the communication between the charging station 10 and the motor vehicle 12, and the charging connection cable 18. The pilot line that is known from the prior art and that is susceptible to interference, in the case of ground-based communication, can be dispensed with completely. Furthermore, the disclosed embodiments of the invention also allow existing communication frameworks based on, e.g., Profinet/Profisafe to be used or imported, and therefore allow Simatic-compatible solutions.

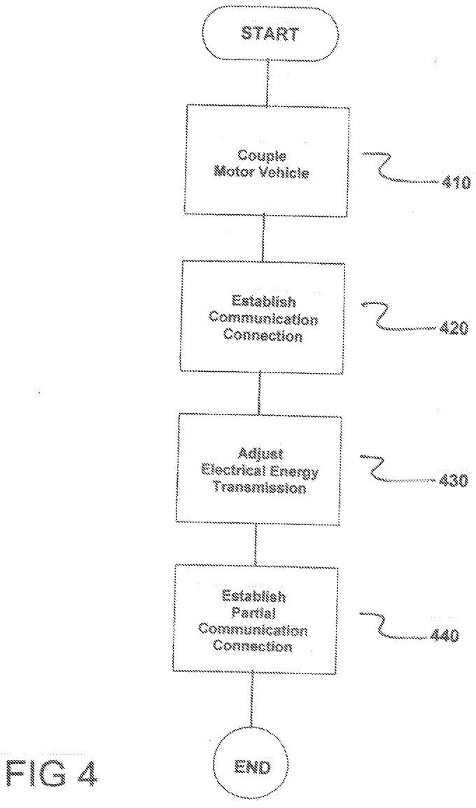

FIG. 4 is a flowchart of a method for transmission of electrical energy between a charging station 10 and a motor vehicle 12 which is electrically coupled to the charging station 10. The method comprises coupling the motor vehicle 12 to the charging station 10 via an electrical charging connection cable 18 having at least two electrical lines 24, 26, as indicated in step 410.

Next, a communication connection is established between the charging station 10 and the motor vehicle 12, as indicated in step 420. Next, the transmission of electrical energy through the charging station 10 is adjusted as a function of energy-store data transferred from the motor vehicle 12 to the charging station 10, as indicated in step 430.

The communication connection is now established at least partially via the at least two electrical lines 24, 26 of the electrical charging connection cable 18 via at least one communication adapter 28 on the charging-station side and at least one communication adapter 30 on the motor-vehicle side, as indicated in step 440.

Overall, however, the invention is not restricted to line-based charging and in principle can also be applied to a wireless energy-compatible coupling, e.g. inductive charging or similar.

The description serves solely to explain the invention and is not intended to restrict it.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A control unit for controlling a charging unit utilized to transmit electrical energy to a motor vehicle which is coupleable to the charging unit via a charging connection cable comprising at least two electrical lines, the control unit comprising:
a communication interface for connecting in a communications-compatible manner to the charging unit, the communication interface being configured to establish a communication connection to the motor vehicle and adjust the transmission of electrical energy through the charging unit as a function of energy-store data received from the motor vehicle; and
a communication adapter which is connectable to the at least two electrical lines to establish the communication connection to the motor vehicle via the at least two electrical lines;
wherein a protocol standard implemented by the communication adapter utilizes a monitoring time to monitor the communication connection.

17. The control unit as claimed in claim 16, wherein the communication adapter is configured to utilize a modulation which is suitable for line properties of the charging connection cable.

18. The control unit as claimed in claim 16, wherein the communication adapter is configured to utilize a digital communication based on a secure protocol standard.

19. The control unit as claimed in claim 16, wherein the monitoring time is less than 20 ms.

20. The control unit as claimed in claim 16, wherein the communication adapter is arranged spatially remote from the control unit.

21. A charging station for transmitting electrical energy between the charging station and a motor vehicle which electrically coupleable to the charging station, the charging station comprising:
a charging unit for transmitting the electrical energy;
a control unit which is coupled in a communications-compatible manner to the charging unit, the control unit being configured to establish a communication connection to the motor vehicle and adjust the transmission of electrical energy through the charging unit as a function of energy-store data received from the motor vehicle, and
an electrical charging connection cable which is electrically coupled to the charging unit and has at least two electrical lines for the electrical coupling of the motor vehicle;
wherein the control unit is configured as claimed in claim 16.

22. The charging station as claimed in claim 21, further comprising:
an energy converter for converting the electrical energy received from the energy source;
wherein the charging unit is connected to an energy source which external to the charging station to receive electrical energy.

23. The charging station as claimed in claim 22, wherein the energy converter includes means for reducing an electromagnetic coupling between the energy source and the electrical charging connection cable.

24. The charging station as claimed in claim 22, wherein the energy converter includes means for at least one of (i) reducing capacitive coupling and (ii) inductive coupling between the energy source and the electrical charging connection cable.

25. The charging station as claimed in claim 22, wherein the energy converter comprises a switched mode energy converter.

26. A charging outlet for a charging station, the charging outlet being arranged spatially remote from a charging unit of the charging station to transmit electrical energy, and being configured to electrically couple to a motor vehicle, the charging outlet comprising:
a control unit which is coupled in a communications-compatible manner to the charging unit, the control unit being configured to establish a communication connection to the motor vehicle and adjust the transmission of electrical energy through the charging unit as a function of energy-store data received from the motor vehicle; and
an electrical charging connection cable which is coupled to the charging outlet and which includes at least two electrical lines for the electrical coupling of the motor vehicle;
wherein the control unit is configured as claimed in claim 16.

27. A motor vehicle comprising:
an electrical energy store;
a charging connection unit which is electrically coupled to the electrical energy store and which includes at least two connection contacts, the charging connection unit being configured for electrical connection of an electrical charging connection cable of a charging station with at least two electrical lines to transmit electrical energy between the charging station and the motor vehicle, and
a vehicle control unit which is configured to establish a communication connection to the charging station and transfer energy-store data relating to the electrical energy store via the communication connection to the charging station to adjust the transmission of the electrical energy as a function of the energy-store data; and
a communication adapter coupled in a communications-compatible manner to the vehicle control unit and connected to the at least two connection contacts to establish the communication connection to the charging station via the at least two electrical lines.

28. A method for transmission of electrical energy between a charging station and a motor vehicle which is electrically coupled to the charging station, the method comprising:
coupling the motor vehicle to the charging station via an electrical charging connection cable having at least two electrical lines,
establishing a communication connection between the charging station and the motor vehicle,
adjusting a transmission of electrical energy through the charging station as a function of energy-store data transferred from the motor vehicle to the charging station; and
establishing the communication connection at least partially via the at least two electrical lines of the electrical charging connection cable via at least one communication adapter on the charging-station side and at least one communication adapter on the motor-vehicle side.

29. The method as claimed in claim 28, further comprising:
indicating a functional readiness of the charging station when the motor vehicle is electrically coupled to the charging station.

30. The method as claimed in claim 29, wherein at least one of (i) a functionality of a protective conductor is tested by the charging station and (ii) a maximum power is communicated to the motor vehicle.

31. The method as claimed in claim 29, wherein at least one of (i) a functionality of a protective conductor is tested by the charging station and (ii) a maximum power is communicated to the motor vehicle.

32. The method as claimed in claim 28, wherein at least one of (i) a charging authorization and (ii) a ventilation is requested by the motor vehicle.

33. The method as claimed in claim 29, wherein at least one of (i) a charging authorization and (ii) a ventilation is requested by the motor vehicle.

34. The method as claimed in claim 30, wherein at least one of (i) a charging authorization and (ii) a ventilation is requested by the motor vehicle.
